(19) United States
(12) Patent Application Publication
(10) Pub. No.: US 2010/0240277 A1
(43) Pub. Date: Sep. 23, 2010

(54) TOY ASSEMBLY

(75) Inventor: Gilles Rapp, Kfar Ben-Nun (IL)

Correspondence Address: BROWDY AND NEIMARK, P.L.L.C.;624 NINTH STREET, NW, SUITE 300, WASHINGTON, DC, 20001-5303, US

(73) Assignee: bTendo Ltd., Kfar Saba (IL)

(21) Appl. No.: 12/738,125

(22) PCT Filed: Oct. 7, 2008
(86) PCT No.: PCT/IL08/01333

§ 371 Date: Apr. 15, 2010

(30) Foreign Application Priority Data
Oct. 15, 2007 (IL) 186652

(51) Int. Cl. A63H 33/26

(52) U.S. Cl. 446/485

(57) ABSTRACT

A toy assembly is provided which comprises: a housing; a processor operative to retrieve display items and forward images comprised in the display items for projection by an optical projecting device; and an optical projecting device adapted for projecting a light beam onto a target plane, thereby projecting the images onto the target plane.

### FIELD OF THE INVENTION

The present invention relates in general to the field of personal projectors, and in particular to the use of such personal projectors in home premises.

### BACKGROUND OF THE INVENTION

One aspect of the invention relates to a device useful for soothing an infant. Typically such devices comprise a decorative body and a moving element connected to the body and disposed below it. The body is generally large compared to the moving element and the body is preferably the dominant decorative (non-functional) feature of the device as a whole. The moving element moves rhythmically and persistently, e.g. in a pendular fashion. The moving element can be a simple structure, such as an arrow or ball. Preferably, the device produces a rhythmic sound synchronized with the motion of the moving element. The moving element, together with the optional sound, can draw an infant's attention, causing the infant to become calm and quite. Such devices are adapted to hang over a crib, infant bed, etc. whereby the device can be conveniently used to sooth an infant.

A number of publications proposed various improvements to such devices. To name but few, U.S. Pat. No. 6,702,643 discloses an infant entertainment device and a support assembly for positioning the entertainment device in view of an infant. The support is reconfigurable between an expanded configuration and a collapsed configuration, and the entertainment device is responsive to actuation of a motion detector coupled to the entertainment device. U.S. Pat. No. 5,672,088 describes an infant mobile that has a main housing attached to a crib, travel bed, changing table or other article of infant's furniture and a clamping assembly adapted for use with a furniture piece.

DE 19738410 discloses a soothing device which has an acoustic reproduction device for providing heart beat, pulse tones or similar signals, incorporated in a soft toy which can be placed in the bed with the infant or child. The acoustic reproduction device may be provided by a microchip, e.g. a PROM or EPROM chip and a loudspeaker coupled to a volume control.

Other mobiles and infant toys are provided for example with an electric motor comprised in the upper housing connected by an electrical circuit to batteries in the lower housing. The motor rotates an eye which, in turn, supports cross arms and mobile figures. A music box inside the lower housing provides audible accompaniment to the rotating motion of the cross arms and mobile figures.

Examples of some further products available in the market are Symphony in motion Mobile that plays 15 minutes of Mozart, Bach, or Beethoven, or a rotating pattern of all three. It operates by remote control, colorful beads slide with each rotation. Wave to Sleep Mobile of First Years plays four soothing music selections—classical, lullaby, soothing spa, and nature sounds, provide with automatic shut-off after 10 minutes and adjustable volume. Fisher-Price are the manufacturers of Ocean Wonders Aquarium mobile that has softly glowing lights, calming music, serene sounds, where the baby can start motion, lights and sounds, and of Mix & Match Mobile that is attached to the crib baby and can take up to 3 different discs.

The present invention seeks to provide a different solution that can be adapted to sooth infants and/or other uses as will be further elaborated.

### SUMMARY OF THE INVENTION

It is an object of the present invention to provide a device for use as an infant toy which incorporates a projector and enables projection of images or video clips onto a surface at the vicinity of the infant.

It is another object of the present invention to provide a toy assembly that allows adapting the projection of the images or video clips onto different target planes.

It is yet another object of the present invention to provide a toy assembly that allows projecting images with or without a sound track.

It is still another object of the present invention to provide a toy assembly that enables changing the contents played thereby, preferably to match the development and/or interest of the viewer.

Other objects of the invention will become apparent as the description of the invention proceeds.

According to a first embodiment of the present invention there is provided a toy assembly which comprises a housing preferably shaped in a toy shape, a processor operative to retrieve display items and forward images comprised in the display items retrieved for projection by an optical projecting device, and an optical projecting device operative to project a light beam onto a target plane, thereby projecting the required images onto the target plane. As will be appreciated by those skilled in the art, projection of the images can be done by projecting a plurality of single slides/photos/pictures (stills) or by projecting video clip(s).

The term “display items” as used herein should be understood to encompass images, video, text (e.g. time, date, weather conditions, notes and the like), animations and pictures, all with or without sound track(s) played while accompanying the display.

According to a preferred embodiment of the invention, the housing comprises a first portion that comprises an optical device for transferring the light beam onto the target plane and a connecting member which connects that first portion with another part of the toy assembly, whereas the connecting member is adapted to allow changes in the positioning of the first portion with respect to the remaining part of the housing, thereby allowing three dimensional angular adjustments of the first portion and consequently enabling the projection of the images onto different target planes, without having to move the remaining of the housing from its current position. Such a connecting member can be a joint, a flexible extendable member and the like. Preferably, the toy assembly further comprises means for locking the first portion at a selected position, and more preferably, the means for locking are part of the connecting member itself. As will be appreciated by those skilled in the art, one of the options of implementing this embodiment is by including in that first portion a device which is operative for carrying out the complete optical functionality required for generating and projecting the light beam onto the target plane. In the alternative, this optical functionality may be divided between the first portion and other part(s) of the toy assembly as long as the part comprised in that first portion is capable of receiving the deflected light beam and allowing its transfer onto the target plane.

In accordance with another preferred embodiment of the invention, the toy assembly further comprises a storage means operative to store display items with or without associated sound track(s). As will be appreciated by those skilled in the art, the display items can either be embedded on a microchip comprised in the storage means, or be downloaded from a computer or any other similar device such as an MP player, a telephone, a DVD, a television etc., or be downloaded from a media that can be inserted thereto (e.g. a CD), or any combination of the foregoing. All these and other similar options should be understood as being encompassed by the present invention.

According to a preferred embodiment of the invention, the toy assembly further comprises a clamping assembly which has a portion (e.g. a base) that is preferably removably mountable on the housing. A mechanism (such as a screw for example) is mounted on that portion (the base). A pressure pad is operatively connected to and moved by the mounted on the base, to a position where it frictionally engages part of an infant furniture piece so as to clamp the clamping assembly and its attached housing to the furniture piece. In the alternative, the toy assembly preferably has a pressure knob mountable on the housing for connecting the toy assembly to the infant furniture piece.

Preferably, the toy assembly is adapted to be connected to the infant furniture piece so that the images can be projected onto a surface observable by an infant lying on or sitting in a crib, travel bed, changing table, safety chair or other infant furniture piece, e.g. over the area where the infant is lying.

According to another preferred embodiment of the invention, the display items are selected in accordance with the infant development e.g. infant's age. The selection of the suitable display items can be made preferably from among a plurality of display items pre-stored in the toy assembly storage means. In the alternative or in addition, display items can be stored on a removable media such as a CD, and the CD may be replaced when different display items should be displayed.

Preferably, the optical device of the toy assembly comprises a ray generating device (e.g. laser, light bulb, led, etc.) whose rays are focused to form a light beam that is directed onto a first spring-mounted mirror that oscillates about a horizontal axis, and the beam deflected by the first mirror being casted directly or indirectly on a second spring-mounted mirror that oscillates about a vertical axis. The beam deflected by the second mirror is casted directly or indirectly on and scans the remote surface to produce a light trace thereon whose path is the resultant of the concurrent oscillations of the two mirrors to create the presentations whose patterns depend on the frequencies and amplitudes of the oscillations to be shown onto the surface observable by the infant.

In the alternative, the optical device of the toy assembly comprises a ray generating device whose rays are focused to form a light beam that is directed onto a two dimensional bi-axial spring-mounted mirror assembly that is capable of oscillating about a horizontal axis and a vertical axis, and the beam deflected therefrom is casted directly or indirectly on and scans the remote surface to produce a light trace thereon whose path is the resultant of the concurrent two dimensional oscillations of the mirror assembly to create the presentations to be shown onto the surface observable by the infant.

In the alternative, the optical device of the toy assembly comprises:
a first planar reflector disposed in a path of a focused light beam for deflecting a light beam incident thereon, where the first planar reflector being movable about a first axis;
a concave reflective surface fixed in position in the path of the deflected light beam, where the concave reflective surface is characterized by having a circular shape extending along at least one of its axis and wherein the reflective surface being spaced from the planar reflector by a distance which is approximately equal to the radius of the circular shape; and
a second planar reflector moveable about a second axis located in a plane substantially vertical to a plane comprising the first axis and wherein the second planar reflector is positioned in the path of the light reflected by the concave reflective surface such that the light beam is projected directly or indirectly onto a target plane with a substantially flat field of focus.

By still another embodiment of the invention there is provided a computer program product encoding a computer program for execution by a toy assembly of the present invention, and wherein the computer program encodes contents to be projected as images by the optical projecting device onto the target plane.

### BRIEF DESCRIPTION OF THE DRAWINGS

For a more complete understanding of the present invention, reference is made to the following detailed description taken in conjunction with the accompanying drawings wherein:

FIG. 1 presents an example of a toy assembly according to an embodiment of the present invention mounted on a crib;

FIGS. 2A and 2B illustrates some of the features associated with the toy assembly of FIG. 1;

FIG. 3 presents another example of a toy assembly according to an embodiment of the present invention mounted on a crib and projecting an image onto a wall next to the crib;

FIG. 4A show the toy assembly of FIG. 3 mounted on a different piece of furniture; and

FIG. 4B show certain features in the toy assembly of FIGS. 3 and 4A.

### DETAILED DESCRIPTION OF THE INVENTION

A better understanding of the present invention is obtained when the following non-limiting detailed description is considered in conjunction with the following Figures.

The following are examples demonstrating certain ways of carrying out embodiments of the present invention.

In the first month of their lives, babies have a visual acuity of about 20/120. Fine depth perception is first developed at 3 to 5 months of age. By 3 months of age they are able to follow an object with smooth eye motions, as long as it is not moving too fast. By 4 months of age, acuity improves by a factor of 2, to 20/60 vision. By 8 months of age, the nervous system has matured enough to improve acuity again by a factor of 2 to 20/30, and is now nearly as good as normal adult acuity 20/20. Over the next several years, acuity improves gradually to an adult level. Therefore, it is particularly desirable to be able to change the images being displayed to the infant during the first year of its life by way of adapting the images to its vision capabilities. Even if the images or some of the images are the same, still by changing their dimensions, colors, brightness, resolution etc., they will be more interesting to the infant who will be more attracted to them.

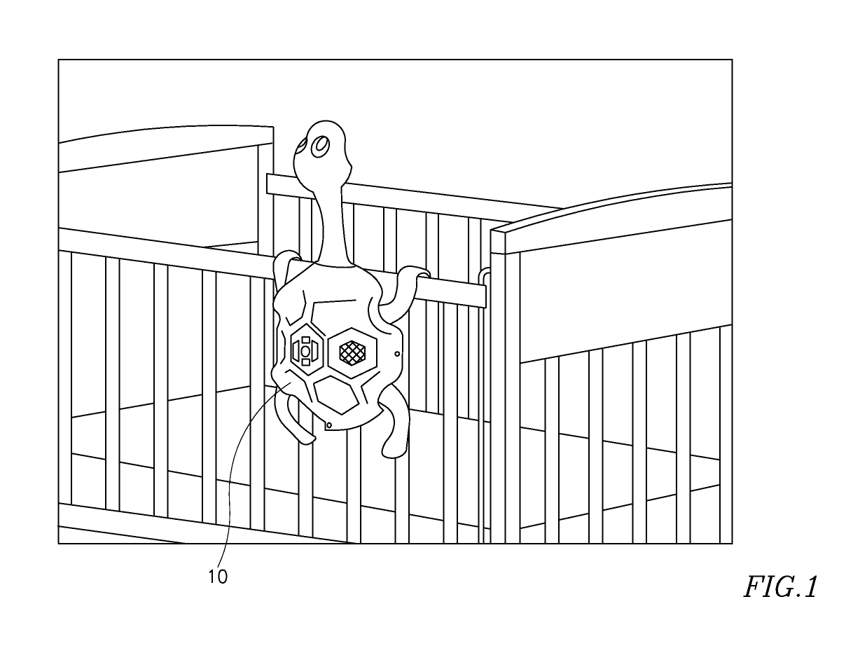

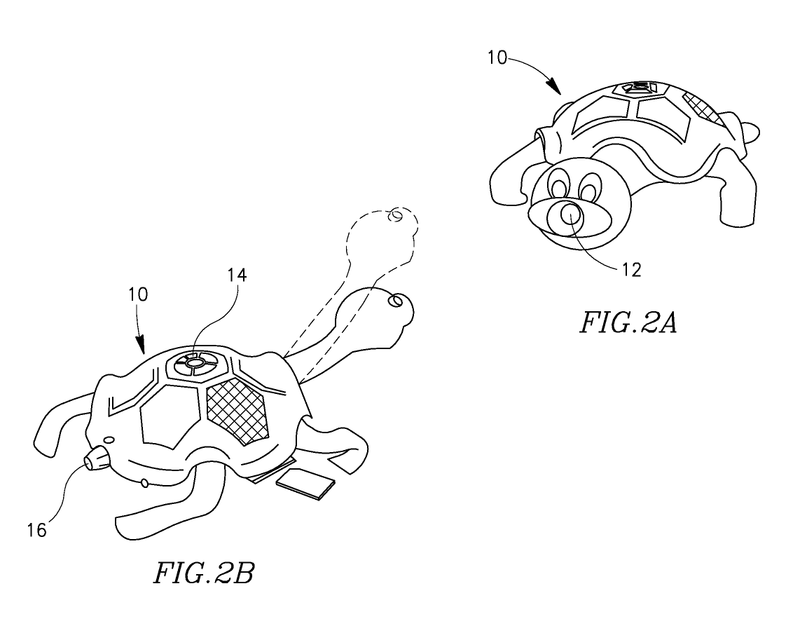

Let us now consider for example FIG. 1 and FIGS. 2A and 2B which present an example of a toy assembly 10 according to an embodiment of the present invention. As may be seen in these Figs, the exemplified toy assembly is provided with an adjustable neck (FIG. 2B) to enable different positioning of the turtle's head (different inclination with or without different planar positioning), thereby providing adjustments of the location of the projections by the optical device which is located in the turtle head (the outermost lens of the optical module 12 is shown in FIG. 2A) and consequently as well as the viewing angle of the viewer. Toy assembly 10 may further comprise means for locking the turtle's at a selected inclination, to ensure the continued projection of the images at the required location. In addition, the turtle may further include audio means which comprise a loudspeaker so that the images being projected can be accompanied by sounds such as music, etc. Thus, the turtle's tail as depicted in FIG. 2B is used as a loudness selector 16 to allow adjusting the sound level as required. Also, as shown in FIG. 2B, an image control console 14 is installed at the back of the turtle, allowing manipulation of the display items (e.g. by selecting content to be projected, sound track, brightness, colors, and/or other image characteristics as applicable). In addition, the toy assembly may be provided with an outlet for an external microphone and built in amplifier.

As previously discussed the toy assembly of the present invention also enable adapting the output thereof to the development/age of the baby by way of adapting the content of images, music and sounds, e.g. by easily installing extension packages (such as an SD card, Bluetooth, Wi-Fi and the like). The toy assembly may be adapted to allow audiovisual track selection, by playing sounds and music using its own speaker and/or through a port which allows its connection to one or more external speakers. Also, the group of display items can be arranged in a one presentation group so that upon operating the toy assembly, they will be serially displayed. The parent may select to show the presentation once per a pre-defined period of time, or in a loop configuration, or to stop presentation after having shown the display items for a pre-defined number of times or a pre-defined duration, or in any way that would be found suitable. Preferably, the toy assembly also comprises and inlet port operative to allow connecting the toy to an external device such as a computer, and downloading therefrom display items and/or operating instructions.

By an embodiment of the invention, the toy assembly may further be provided with a remote control to allow operating/stopping its operation remotely by using any member of the group comprising: an IR remote control, a Bluetooth control, a Wi-Fi control, a cellular remote control (which would also allow a parent that receives an indication that the baby is crying, to activate the toy assembly even from out of the house), and the like, or any combination thereof.

The power source for operating the assembly may preferably be batteries (for example rechargeable batteries, rechargeable power module (which is preferably detachable from the toy assembly housing, etc.), or may be connected to the premises power supply.

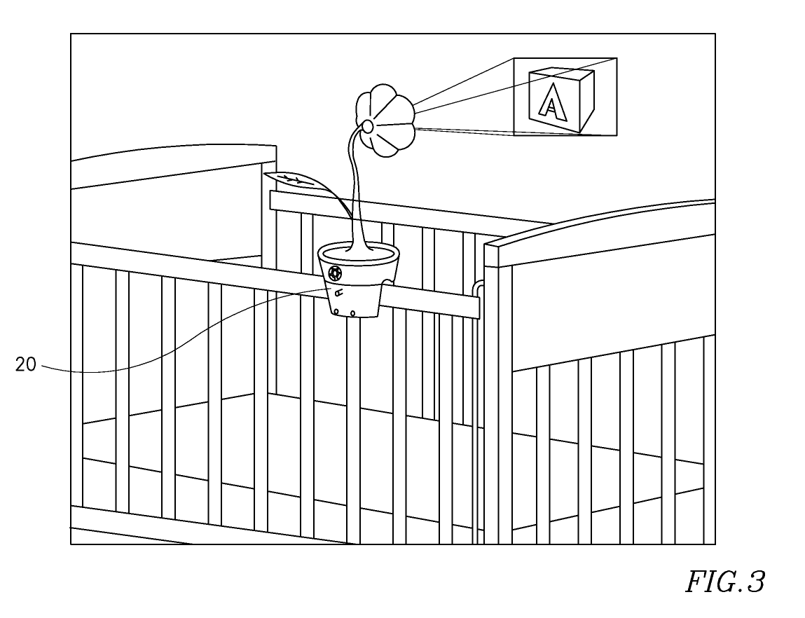

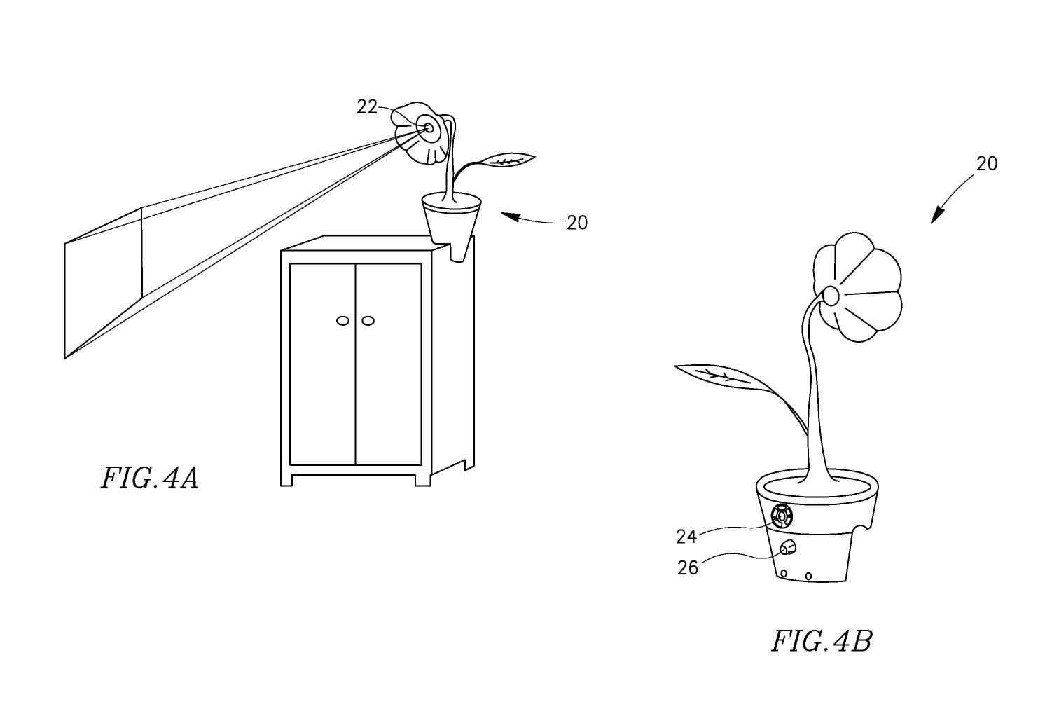

FIG. 3 illustrates another example of a toy assembly 20 according to an embodiment of the present invention mounted on a crib and projecting an image onto a wall next to the crib and FIG. 4A shows that toy assembly 20 mounted on a different piece of furniture. As can be seen the toy assembly can easily be mounted on baby's crib, bed, table, shelves, chair, car seat etc, and the animations and images may be projected on any surface: ceiling, wall, floor, back of driver seat, etc. When the child grows up the content may be replaced to match his/her age either by simply replacing a media (e.g. CD) carrying the display items, with a more appropriate one (e.g. to allow teaching the child how to read, pre-school calculus etc.), or if the storage within the toy assembly already comprises a software that includes various items preferably arranged in different folders for the different ages such as images, animations, video clips and the like, the appropriate item(s)/folder will be selected and the selected items can be played by operating the toy assembly until other item(s)/folder are selected. FIG. 4B, similarly to FIG. 2B mutates mutandis, presents certain optional features of the toy assembly 20 such as a control console 24 and a loudness selector 26.

It is to be understood that the above description only includes some embodiments of the invention and serves for its illustration. Numerous other ways of carrying out the methods provided by the present invention may be construed by a person skilled in the art without departing from the scope of the invention, and are thus encompassed by the present invention.

For example, it should be clear to any person skilled in the art that the functionalities required to carry out the present invention may be divided differently between the toy assembly and the remote control. To name but few, the activation of the display, control over the content being displayed, control of auxiliary devices such as speakers, etc. It should be understood that any such shifting a functionality from the toy assembly and the remote control and vice versa, is a matter of simple selection and can be done without departing from the scope of the present invention. Also the projected images can be utilized in many different ways, such as to be observed by an infant lying, for educational purposes by a toddler learning to read/math etc., as a contour being projected onto a surface and used by a child as the boundaries of a painting.

1. A toy assembly comprising: a housing; a processor operative to retrieve display items and forward images comprised in said display items for projection by an optical projecting device; and an optical projecting device adapted for projecting a light beam onto a target plane, thereby projecting said images onto said target plane.

2. A toy assembly according to claim 1, further comprising an electronic storage means operative to store display items.

3. A toy assembly according to claim 1, further comprising means to enable downloading of display items from an external source for display by said toy assembly.

4. A toy assembly according to claim 1, wherein said housing comprises a first portion that comprises an optical device for transferring the light beam onto the target plane and a connecting member which connects said first portion with another part of said toy assembly, whereas said connecting member is adapted to allow changes in the positioning of said first portion with respect to the remaining part of said housing, allowing for three dimensional angular adjustments of said first portion thereby enabling the projection of said images onto different target planes.

5. A toy assembly according to claim 1, further comprising audio means adapted to play audio signals while said images are being projected onto said target plane.

6. A toy assembly according to claim 1, wherein the display items are pre-arranged in a form that allows playing them serially.

7. A toy assembly according to claim 1, further comprising a clamping assembly to enable attaching said toy assembly housing to a furniture piece.

8. A toy assembly according to claim 1, wherein said optical device is comprised within a movable portion of said toy assembly, and wherein said portion is movable to different positions thus allowing adjusting the projections made by the optical device onto said target plane.

9. A toy assembly according to claim 7, further comprising means for locking said moveable portion at a selected position.

10. A toy assembly according to claim 1, further adapted to allow changing display items being played to adapt their contents to the viewer.

11. A toy assembly according to claim 1, wherein said optical device comprising a ray generating device whose rays are focused to form a light beam that is directed onto a first spring-mounted mirror that oscillates about a horizontal axis, and wherein a beam deflected by said first mirror being casted directly or indirectly on a second spring-mounted mirror that oscillates about a vertical axis, and wherein said beam deflected by said second mirror is casted directly or indirectly on and scans said target plane to produce a light trace thereon.

12. A toy assembly according to claim 1, wherein said optical device comprising a ray generating device whose rays are focused to form a light beam that is directed onto a two dimensional spring-mounted mirror assembly, capable of oscillating about a horizontal axis and a vertical axis, and wherein said beam deflected therefrom is casted directly or indirectly on and scans said target plane to produce a light trace thereon.

13. A toy assembly according to claim 1, wherein said optical device comprising a ray generating device whose rays are focused to form a light beam;
a first planar reflector disposed in a path of a focused light beam for deflecting a light beam incident thereon, where the first planar reflector being movable about a first axis;
a concave reflective surface fixed in position in the path of the deflected light beam, where the concave reflective surface is characterized by having a circular shape extending along at least one of its axis and wherein the reflective surface being spaced from the planar reflector by a distance which is approximately equal to the radius of the circular shape; and
a second planar reflector moveable about a second axis located in a plane substantially vertical to a plane comprising the first axis and wherein the second planar reflector is positioned in the path of the light reflected by the concave reflective surface such that the light beam is projected directly or indirectly onto a target plane with a substantially flat field of focus.

14. A computer program product encoding a computer program for execution by a toy assembly of claim 1, wherein said computer program encodes contents to be projected as images by said optical projecting device onto said target plane.
